(19) United States
(12) Patent Application Publication
(10) Pub. No.: US 2024/0330863 A1
(43) Pub. Date: Oct. 3, 2024

(54) SYSTEM, METHOD, AND COMPUTER PROGRAM FOR LARGE LANGUAGE MODEL PROCESSES FOR DEEP JOB PROFILE CUSTOMIZATION AND TALENT PROFILE CUSTOMIZATION

(71) Applicant: Eightfold AI Inc., Santa Clara, CA (US)

(72) Inventors: Sanjeet Hajarnis, Santa Clara, CA (US); Batuhan Akcay, Santa Clara, CA (US); Yovahn Hoole, Santa Clara, CA (US); Arindum Roy, Santa Clara, CA (US); Manav Mehra, Santa Clara, CA (US); Max Colbert, Santa Clara, CA (US); Surya Vakkalanka, Santa Clara, CA (US)

(73) Assignee: Eightfold AI Inc., Santa Clara, CA (US)

(21) Appl. No.: 18/608,805

(22) Filed: Mar. 18, 2024

Related U.S. Application Data
(63) Continuation-in-part of application No. 18/195,545, filed on May 10, 2023.
(60) Provisional application No. 63/454,934, filed on Mar. 27, 2023.
(60) Provisional application No. 63/454,943, filed on Mar. 27, 2023.
(60) Provisional application No. 63/340,116, filed on May 10, 2022.

(51) Int. Cl. G06Q 10/1053; G06Q 10/0631

(52) U.S. Cl. CPC G06Q 10/1053; G06Q 10/063112

(57) ABSTRACT

A system and method perform obtaining a request for generating a job description directed towards job candidates, performing pre-processing operations on the request to generate a prompt to a large language model engine, submitting the prompt to the large language model engine and receive a job description generated by the large language model engine, performing post-processing operations on the generated job description to generate a customized job description, and providing the customized job description to a user interface for presentation.

### REFERENCE TO RELATED APPLICATIONS

This application claims priority benefit to U.S. Provisional Application No. 63/454,943 filed on Mar. 27, 2023 and to U.S. Provisional Application No. 63/454,934 filed on Mar. 27, 2023. This application is a continuation-in-part of U.S. application Ser. No. 18/195,545 filed on May 10, 2023, which claims priority benefit to U.S. Provisional Application No. 63/340,116 filed May 10, 2022. The contents of the above-mentioned applications are hereby incorporated in references in their entireties.

### TECHNICAL FIELD

The present disclosure relates to improvements to computer technologies such as machine learning and artificial intelligence (AI) including generative AIs and generative large language models (LLM), and in particular to in particular to a system, method, and storage medium including executable computer programs for large language model processes for deep job profile customization and candidate customization.

### BACKGROUND

An organization such as a company may need to hire in the job marketplace to fill job openings. To achieve its hiring goals, the organization may post these job openings in the media such as the company's career website, printing media, or other social network sites. These posts of job openings may include job descriptions. A job description may include a job title, requisite skills, years of experience, education levels, and desirable personality traits. The job description is typically drafted by a human resource (HR) manager who may specify the job title, requisite skills, years of experience, education levels, and desirable personality traits based on the HR manager's personal evaluation and judgement.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system implementing a software application for deep job profile customization according to an implementation of the disclosure.

FIG. 2 illustrates pre-processing operations according to an implementation of the disclosure.

FIG. 3 illustrates a graphic user interface according to an implementation of the disclosure.

FIG. 4 illustrates an example job description that is generated by an LLM engine.

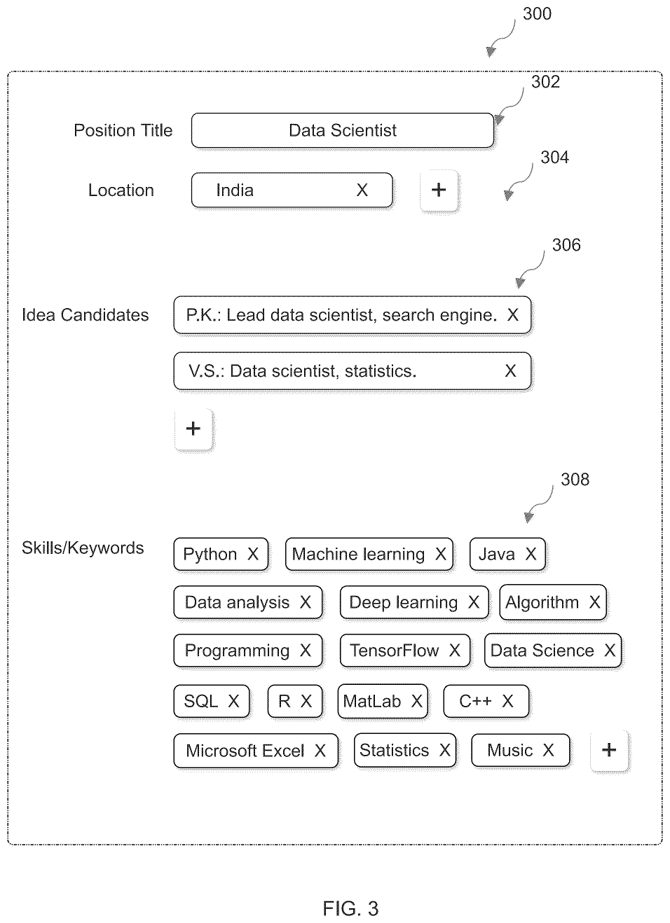

FIG. 3 illustrates a Bidirectional Encoder Representations from Transformers (BERT) model that may be trained to convert words or phrases into embedding vectors according to an implementation of the disclosure.

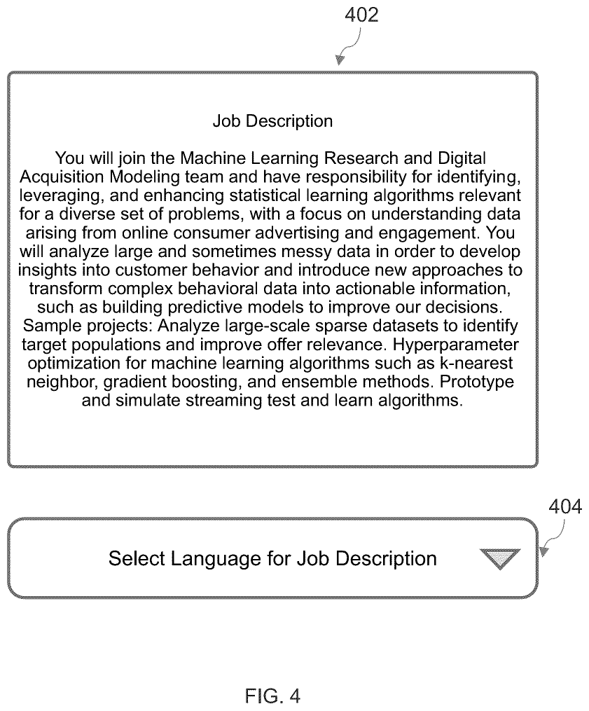

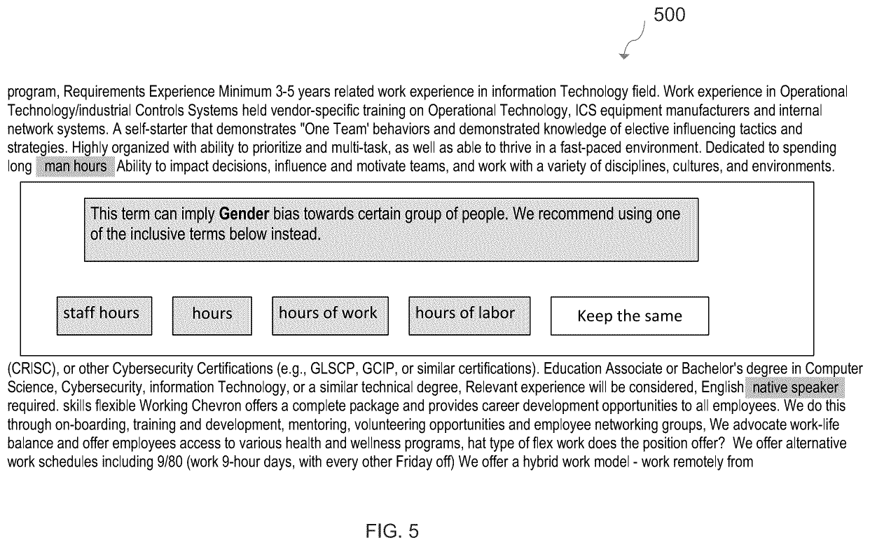

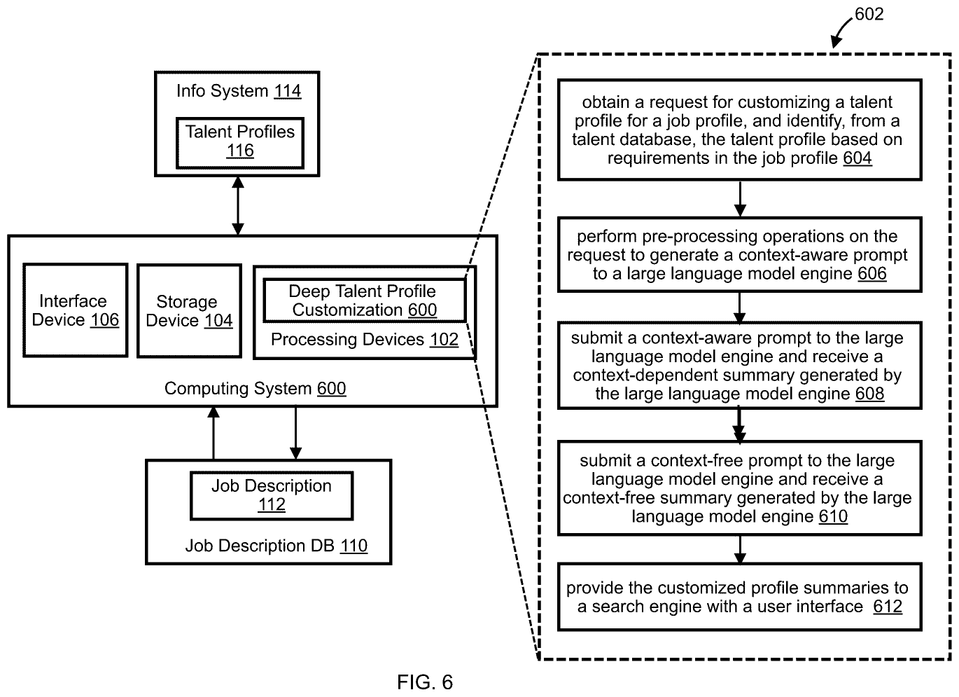

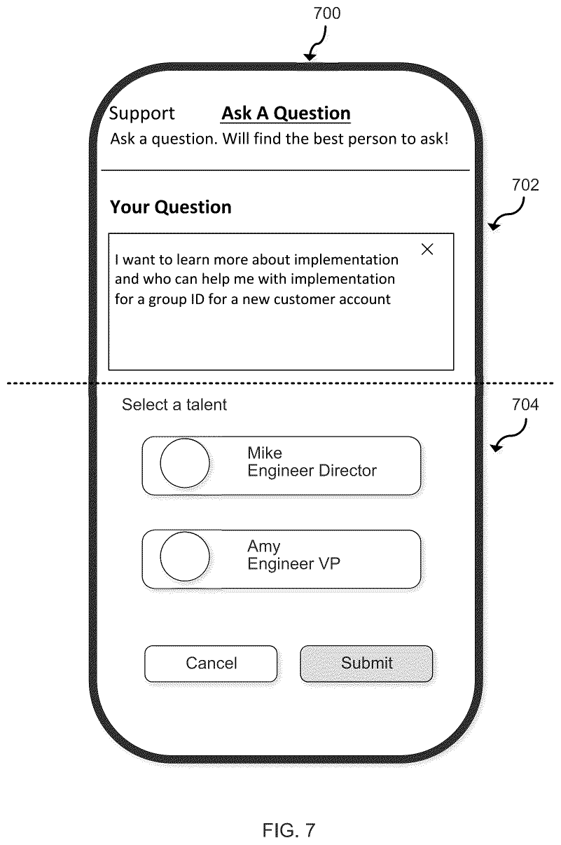

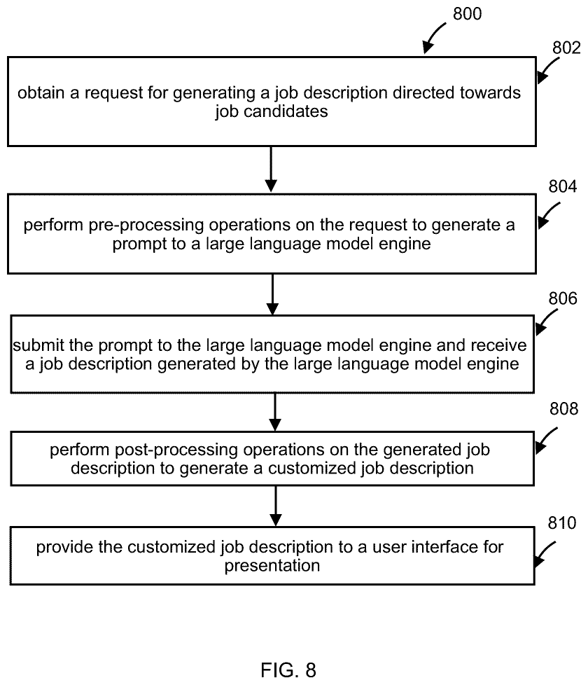

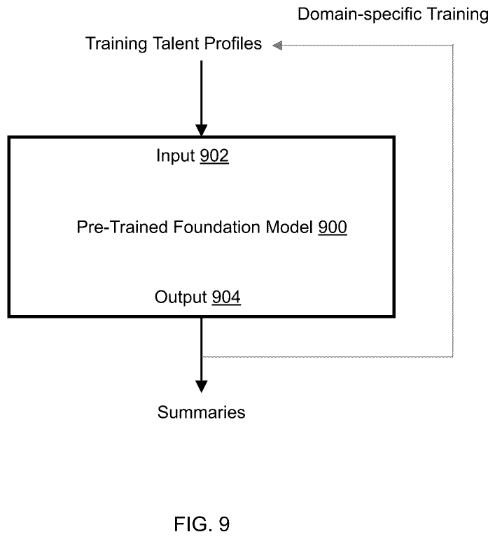

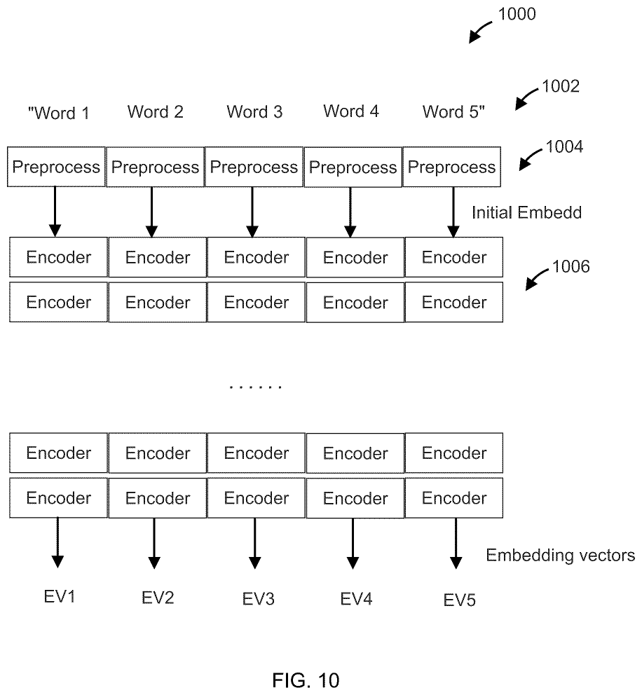

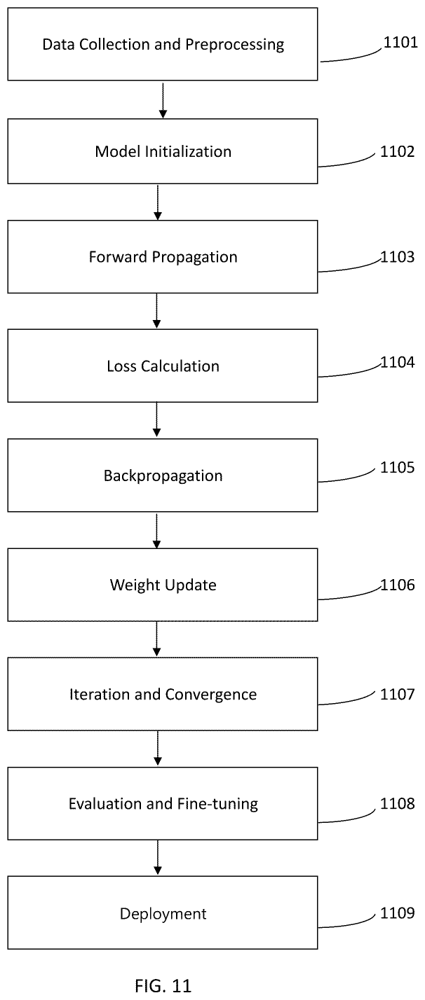

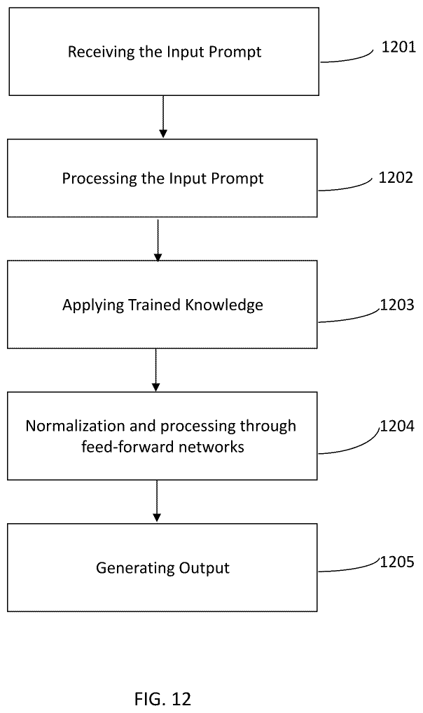

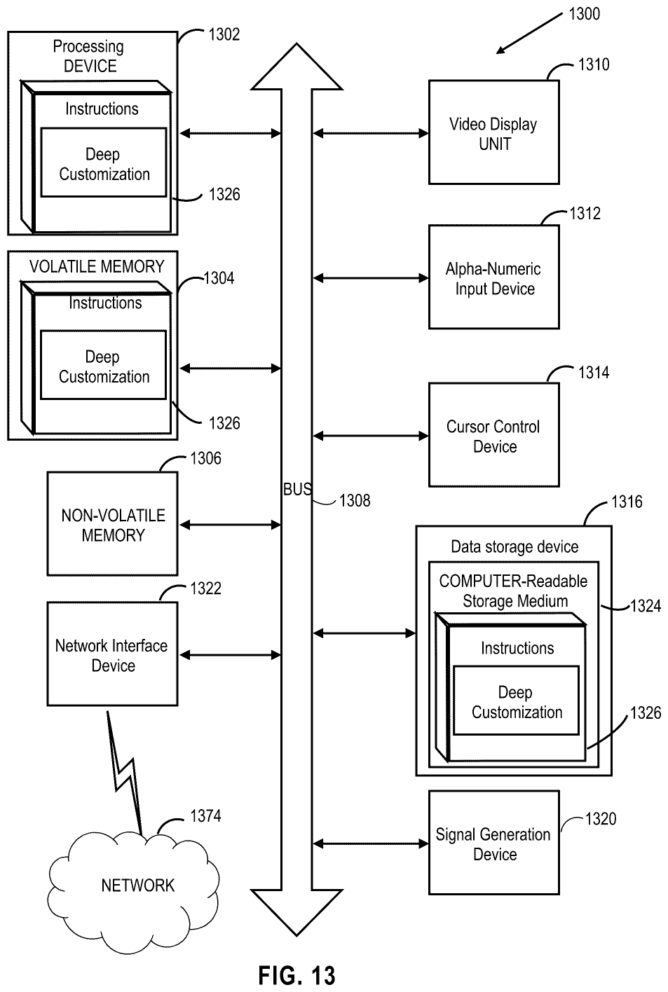

FIG. 4 illustrates a system for comparing the job description with qualified talent profiles using embedding vectors according to an implementation of the disclosure.

FIG. 5 illustrates another user interface for a user to select alternative inclusive words for exclusive words.

FIG. 6 illustrates the computer system implementing a software application for deep talent profile customization according to an implementation of the disclosure.

FIG. 7 illustrates another user interface for question and answer based on a deep talent profile customization provided to a search engine.

FIG. 8 illustrates a flowchart of a method for deep job profile customization according to an implementation of the disclosure.

FIG. 9 illustrates a neural network module that may be used to calculate embedding vectors according to an implementation of the disclosure.

FIG. 10 illustrates a Bidirectional Encoder Representations from Transformers (BERT) model that may be trained to convert words or phrases into embedding vectors according to an implementation of the disclosure.

FIG. 11 illustrates an example of a training process of an LLM neural network module.

FIG. 12 illustrates an example of the operation stages of an LLM neural network module.

FIG. 13 depicts a block diagram of a computer system operating in accordance with one or more aspects of the present disclosure.

### DETAILED DESCRIPTION

A manually-crafted job description for advertising a job often suffers issues such as that it may not fully capture all aspects of the job, thus prohibiting identification of the best job candidates for the job. For example, the job description may include overly-stringent or wish-list job skill requirements that may exclude certain qualified candidates from the job opening. In addition to the less comprehensiveness, the manually-crafted job descriptions may highly depend upon the personal knowledge of the drafter, and can be less correlated to true requirements including implicit skill requirements for the job. These deficiencies may prohibit cross-discipline hires. In certain situations, a talent profile of a candidate from another field may also be well qualified for the job opening. Further, the manually-crafted job descriptions may be drafted in a way that is influenced by the drafter's personal biases. The personal biases can be conscious and/or unconscious and may include multiple types of biases such as, for example, affinity bias and similarity bias that may result in the tendencies to describe job requirements in a way that targets the candidates similar to the drafters or the preferences of the drafters. The biases embedded in the job description may prevent the job description from appealing to a diverse talent pool, thus limiting the selection and composition of the candidates.

U.S. Pat. No. 10,803,421 (“System, method, and computer program for automatically predicting the job candidates most likely to be hired and successful in a job”) by the same applicant describes a system and method that automatically identify the requirements for a role either as a collection of skills and capabilities, previous experiences or the talent profiles of individuals who have been successful for the role. The content of U.S. Pat. No. 10,803,421 is hereby incorporated by reference in its entirety.

To overcome the above-identified and other deficiencies, implementations of the disclosure provide a system and method that may leverage one or more large language models (LLMs) such as bidirectional encoder representations from transformers (BERT) models or generative pre-trained transformer (GPT) models (e.g., GPT-3, ChatGPT or GPT-3.5, GPT-4) to generate a deep customized job profile (or job description) that may be particularly suitable for a diverse talent pool and reduce the workloads of human resource managers. Implementations may effectively match, at different scales, the lofty hiring goals of an organization. Once the job requirements are gathered, these job requirements can be used as a prompt input to a large language model engine (e.g., prompts to GPT-4 models). LLMs may be particularly suitable for generating relevant, coherent, minimally bias and grammatically-correct job descriptions when provided with a properly designed prompt. One of the primary advantages of generative language models is their ability to generate human-like text. They can generate new text, making them useful for a wide range of applications. Furthermore, in a geographically-diverse organizational environment, multilingual diversity sensitive job descriptions will help serve the organization with better talent pools, and a large language model trained on large corpuses of international languages may be particularly suitable for inter-language context correlation and generation of multiple job descriptions in different languages.

To leverage the LLMs, implementations of the disclosure may provide a system and method that may include one or more computing devices to obtain a request for generating a job description directed towards job candidates, perform pre-processing operations on the request to generate a prompt to a large language model engine, submit the prompt to the large language model engine and receive a job description generated by the large language model engine, perform post-processing operations on the generated job description to generate a customized job description, and provide the customized job description to a user interface for presentation.

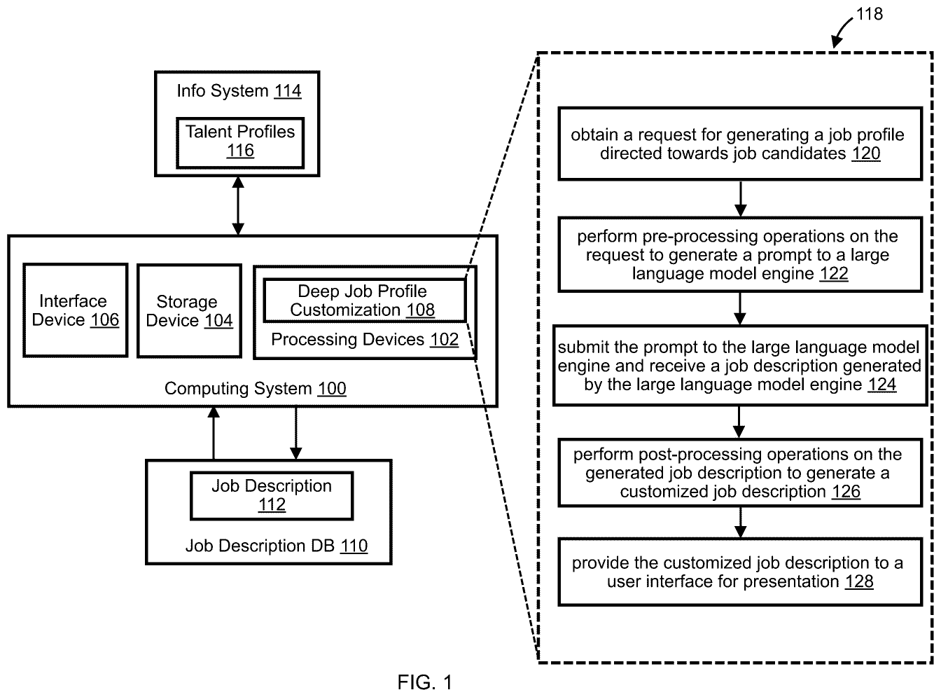

Implementations of the disclosure may be realized by using a stand-alone computing device (e.g., hardware processors) or in a shared computing environment (e.g., a computing cloud). FIG. 1 illustrates a computing system 100 implementing a software application of deep job profile customization application 108 according to an implementation of the disclosure. The deep job profile customization application 108 may leverage a large language model to generate a job description that includes explicit and implicit requirements without biases. Computing system 100 can be a standalone computer or a networked computing resource implemented in a computing cloud. Referring to FIG. 1, computing system 100 may include one or more processing devices 102, a storage device 104, and an interface device 106, where the storage device 104 and the interface device 106 are communicatively coupled to processing devices 102.

A processing device 102 can be a hardware processor such as a central processing unit (CPU), a graphic processing unit (GPU), or an accelerator circuit. Interface device 106 can be a display such as a touch screen of a desktop, laptop, or smart phone. Storage device 104 can be a memory device, a hard disc, or a cloud storage connected to processing device 102 through a network interface card (not shown).

Processing device 102 can be a programmable device that may be programmed to implement a graphical user interface presented on interface device 106. The interface device may include a display screen for presenting textual and/or graphic information. Graphical user interface (“GUI”) allows a user using an input device (e.g., a keyboard, a mouse, and/or a touch screen) to interact with graphic representations (e.g., icons) presented on GUI.

Computing system 100 may be connected to one or more information systems 110, 114 through a network (not shown). These information systems can be human resource management (HRM) systems that are associated with one or more organizations that hire or seek to hire employee candidates to form their workforces (referred to as “talents”). The HIRM systems can track external/internal candidate information in the pre-hiring phase (e.g., using an applicant track system (ATS)), or track employee information after they are hired (e.g., using an HR information system (HRIS)). Thus, these information systems may include databases that contain information relating to applicants, candidates and current employees that are collectively referred to as talents in this disclosure.

Referring to FIG. 1, information system 114 can be an HRM system of an organization that may desire to hire new employees or retain existing employees (collectively referred to as “talents”) with competitive and fair compensation. Information system 114 may include a database that stores the talent profiles 116 of these talents associated with the organization. Each of talent profiles 116 can be a data object that contains data values (referred to as feature values) that may characterize aspects related to a candidate or an employee. These aspects may include, but not limited to, a role and skills of a talent. In one implementation, a talent profile 116 may include a resume possessed by a talent. Thus, talent profile 116 may include sections that describe different aspects of the talent. Each section may include one or more paragraphs and/or sentences of textual descriptions relating to the topic of the section. For example, the sections may include, but not limited to, a personal information section, an objective section, an education section, a work experience section, a skill section, an award and honor section, and a reference section. Each section may include subsections. For example, the work experience may include subsections relating to different jobs that the talent held before. The skill sections may include work-related skills and other skills. Each section may include textual descriptions relating to the topic of the section. For example, a work experience section may include a job title, an employer, skills used, years of experience, responsibilities, and achievements etc. In other implementations, the talent profile 116 may include the resume and other information collected from other sources beyond the resume, and/or predicted feature values calculated based on the resume and the other information collected from other sources.

In some implementations, the talent profile 116 may be used to characterize aspects of a talent who can be an applicant, a candidate or an employee. The talent profile 116 may cover different attribute values such as a job title currently held by the person and job titles previously held by the person, companies and teams to which the person previously belonged and currently belongs, descriptions of projects on which the person worked on, the technical or non-technical skills possessed by the person for performing the jobs held by the person, and the location (e.g., city and state) of the person. The talent profile 116 may further include other attribute values such as the person's education background information including schools he or she has attended, fields of study, and degrees obtained. The talent profile 116 may further include other professional information of the employee such as professional certifications the employee has obtained, achievement awards, professional publications, and technical contributions to public forum (e.g., open source code contributions). Talent profile 116 may also include predicted attribute values that indicate the likely career progress path through the organization if the person stays with the organization for a certain period of time.

Computing system 100 may be connected to a job description database 110 of an organization that may be in the job market to hire employees to fill job openings. The job description database 110 can be part of or separate from information system 114. The job description database 110 may include one or more job descriptions (also referred to as job profiles) 112 associated with job openings. Each job description 112 may specify different attributes required or desired from candidates (collectively, referred to as the job requirements) to fill the corresponding job opening. In one implementation, a job description 112 may include job requirements such as job functions, job titles, teams to which the hire belongs to, projects on which the hire works, job functions, required skills and experience, as well as requisite education, degrees, certificates, licenses etc. The job profiles may also include desired personality traits of the candidates such as leadership attributes, social attributes, and altitudes. In addition to these explicit requirements that can be specified in a textual description, a job profile may also include the talent profiles of employees that had been hired for the same or similar positions and the talent profiles of candidates that the organization considered to hire.

As discussed above, the current practice to prepare a job profile may require a talent manager of the organization to manually draft the job profile. This practice may produce a job profile that suffers insufficiency description of the job requirements and the introduction of personal biases in addition to consuming the time of the drafter. To overcome the above-identified and other deficiencies, implementations of the disclosure provide a deep job profile customization application 108 that includes a software application implemented on processing device 102. Processing device 102 may execute deep job profile customization application 108 to perform operations 118 which may leverage a large language model to generate a high-quality job profile with little or no user intervention.

At 120, processing device 102 may obtain a request for generating a job profile or job description directed to job candidates or applicants. A talent manager may specify the request for generating the job profile or job description in a user interface. The request can be in the form of natural language (e.g., a sentence in English or any suitable natural language). The request may specify a job title and certain specific requirements for the job. For example, a request may state “write a job description for a Data Scientist with two-year Python experience,” where the job title is “Data Scientist” and the specific requirement can be an explicit requirement such as “two-year Python experience.” This request can be presented directly to a large language model engine as a prompt for generating the job description. This request, however, is still phrased quite broadly and does not use all available information. The job description generated based on this broadly-phrased request may be less precise and may contain biases. To further improve the prompt, implementations of the disclosure perform pre-processing operations.

At 122, processing device 102 may perform pre-processing operations on the request to generate a prompt to a large language model engine. The pre-processing operations may help generate a more useful prompt that is substantially free of biases.

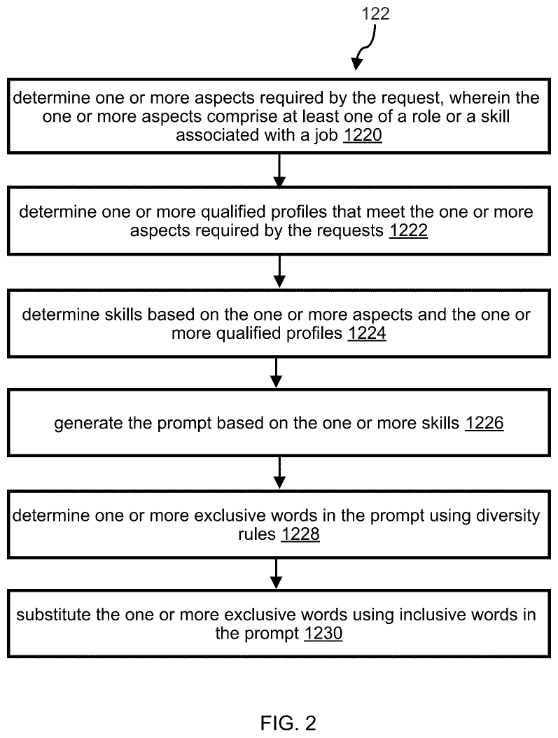

In one implementation, to perform the pre-processing operations, processing device 102 may perform further operations as shown in FIG. 2. FIG. 2 shows pre-processing operations 122 according to an implementation of the disclosure. The operations as shown in FIG. 2 may be assisted with a graphic user interface (GUI) 300 as shown in in FIG. 3. GUI 300 may be implemented on interface device 106 and include GUI elements such as elements 302-308 that may be used to display user-input information and machine-derived information. Here, the machine derived information may be generated based on the request obtained at 120 or derived from talent profiles available to the deep job profile customization application 108. Further, a user may add, delete, or otherwise modify the machine-generated information using GUI 300. To facilitate the performance, one implementation may present GUI 300 to a user (e.g., an HR talent manager) to supplement certain requirements in the user request in the form of aspect values that may characterize a desired talent in a job description. For example, GUI 300 may provide a field 302 for displaying a job title (e.g., “data scientist”) that may be derived from a request or input by a user. GUI 300 may further provide a location field 304 for displaying one or more job locations (e.g., “India”, “San Francisco, U.S.”) that may be derived from a request or input by the user. GUI 300 may further provide a talent field 306 for displaying one or more ideal talents (e.g., one or talent profiles of talents that had been hired before) that may be derived based on the job title and/or location or input by a user. GUI 300 may further provide a skill field 308 including one or more skills (e.g., “Python,” “machine learning”) that may be derived from the talent profiles of ideal talents or input by a user. Processing device 102 may obtain one or more aspect values (e.g., job title) and use the one or aspect values as a starting point to perform pre-processing operations.

Referring to FIG. 2, at 1220, processing device 102 may determine one or more aspects required by the request, wherein the one or more aspects comprise at least one of a role (e.g., the job title) or a skill (e.g., associated with a job. Processing device 102 may obtain user-specified aspect values (e.g., job title or role, job skills, locations, prototype talent profiles etc.) for enriching the request from the graphic user interface. To determine the one or more aspect values, processing device 102 may optionally select the one or more aspect values from the user-specified aspect values entered in the graphic user interface. The selection may be based on rules to choose a subset of the user-specified aspect values. The rules can be, for example, a limited number of aspect values (e.g., 5 most relevant). Alternatively, processing device 102 may elect to use all of the user-specified aspect values as the one or more aspect values.

At 1222, processing device 102 may determine one or more qualified talent profiles that meet the one or more aspects required by the requests. The one or more aspect values specified by the user may be still limited and not sufficient as a prompt for a large language model to generate a high-quality job description. To overcome this deficiency, implementations of the disclosure may search for more useful information for enriching the prompt. The useful information may be obtained from one or more qualified talent profiles other than those specified by the user. The qualified talent profiles can be those talent profiles having a job title that is the same or similar to the ones specified by the user through the graphic user interface, and/or those talent profiles having the one or more skills specified by the user through the graphic user interface, and/or those talent profiles similar to those prototype talent profiles. The similarity between two talent profiles may have pre-calculated and stored in information system 114.

Alternatively, the similarity between two talent profiles or two skills may be determined based on a distance analysis. For example, for a skill requested by the user (e.g., Python), processing device 102 may determine adjacent skills to the requested skill in an embedding vector space based on a distance analysis. The determined one or more talent profiles contain information that may enrich the content of the prompt to the large language model.

At 1224, processing device 102 may further determine one or more skills based on the one or more aspect values and the one or more qualified talent profiles. In one implementation, the enrichment to the prompt may include a broader range of skills to be included in the job description. In addition to the skills specified by the user through the graphic user interface, processing device 102 may identify more skills from the one or more qualified talent profiles. The identified skills can be most frequently appeared skills (e.g., top 5 most frequently skills) in the one or more qualified talent profiles. The one or more skills may include a combination of user-specified skills and those identified or generated from the one or more talent profiles.

At 1226, processing device 102 may rewrite and enhance the query prompt based on the one or more skills, where the prompt is designed to inquire the large language model. The one or more skills may be used to enrich the prompt. For example, if the one or more skills include “deep learning,” “TensorFlow,” “C++” in addition to Python, processing device 102 may rewrite the user-specified prompt of “write a job description for a Data Scientist with two-year Python experience” to “write a job description for a Data Scientist with two-year experience of Python, deep learning, TensorFlow, and C++,” thus generating a more precise prompt for eliciting more accurate job description. The skills belong to one of many types of requirements that may be enriched during pre-processing operations. Similar to the determination of skills, processing device 102 may also determine other requirements (e.g., years of experience for a corresponding skill, certificates, degrees, publications, rewards, social activities, volunteer works etc.) using steps similar to steps 1222-1224, and generate the prompt based on the skills and one or more of these requirements. In this way, through the machine decomposition and automatic identification of components of the job requirements, and further combination of the components and adjacency information of these components, targeted prompts are built to be used as inputs to a large language model, which can help generate ideal job descriptions, customized for the job profile.

In one implementation, the prompt may be further enriched with a natural language requirement. A large organization such as an international company with offices in multiple countries with different official languages. The company may desire to hire in multiple countries to fulfill job openings having the same job profile. Thus, the prompt may include requirement to write in one or more languages. In one implementation, the processing device may determine one or more languages based on the hiring locations. For example, if the user-specified hiring locations include San Francisco, California and Mexico City, Mexico, the language requirement may include English and Spanish. Thus, the prompt may be further enriched to “write a job description for a Data Scientist with two-year experience of Python, deep learning, TensorFlow, and C++ in English and Spanish.”

The generated prompt can be provided to a large language model engine for generating the job description. The generated job description can be in one or more languages (e.g., English, Spanish, Germany etc.). In some situations (e.g., required by law, required by company's policy), the job description needs to be inclusive and free of bias words. The text of the job description should take into account diversity and inclusiveness factors. It may be helpful to have an additional layer of inclusiveness check that evaluates the underlying text for exclusive words and suggests inclusive alternatives in reference to the context of the underlying text. Exclusive language refers to the use of words or phrases that may tend to favor certain individuals or groups based on protected characteristics such as their race, color, gender, sexual orientation, age, ability, etc. Exclusive language affects both individuals and organizations.

To facilitate the generation of an unbiased job description, the prompt may need to be free of exclusive words or bias words. One implementation may first ensure that the prompt is free of exclusive words or phrases. To this end, at 1228, processing device 102 may determine if the generated prompt contains one or more exclusive words using diversity rules. In one implementation, processing device 102 may compare words in the generated prompt against an exclusive word dictionary to determine if the generated prompt contains one or more exclusive words. At 1230, responsive to determining that the generated prompt contains one or more exclusive words, processing device 102 may substitute the one or more exclusive words using inclusive words in the generated prompt, thus producing an unbiased prompt.

Referring to FIG. 1, at 124, processing device 102 may submit the generated prompt to the large language model (LLM) engine and receive a job description generated by the large language model engine. The LLM engine may be locally implemented by processing device 102 or alternatively remotely implemented in a computing cloud that can be accessed based on a subscription (e.g., the OpenAI ChatGPT platform, Google Gemini platform).

A large language model (LLM) in this disclosure refers to a deep learning model that may achieve general-purpose language generation and understanding by learning statistical relationships from text documents during a training process. The training process can be a supervised or self-supervised training. The underlying neural networks for LLMs can be based on transformers which include encoders and decoders.

A Large Language Model (LLM) implemented on a computer system or computing cloud is referred to as an LLM engine which can be configured to receive, interpret, and generate human-like text based on input prompts, leveraging a deep neural network architecture. This system may include multiple operational stages designed to understand and manipulate natural language text in a manner that mimics human cognitive abilities, thereby facilitating a wide range of applications from automated content creation to interactive dialogue systems. Once an LLM has been trained, the LLM may process input prompts and generate outputs that are coherent and contextually appropriate.

LLMs may be implemented using different types of neural network modules. FIG. 9 illustrates a neural network module 900 that may be used to calculate embedding vectors according to an implementation of the disclosure. The neural network module 900 may be a deep neural network (DNN) that may include multiple layers, in particular including an input layer for receiving data inputs, an output layer for generating outputs, and one or more hidden layers that each includes linear or non-linear computation elements (referred to as neurons) to perform the DNN computation propagated from the input layer to the output layer that may transform the data inputs to the outputs. Two adjacent layers may be connected by edges. Each of the edges may be associated with a parameter value (referred to as a synaptic weight value) that provide a scale factor to the output of a neuron in a prior layer as an input to one or more neurons in a subsequent layer.

Referring to FIG. 9, neural network module 900 may include an input layer including an input 902 to receive, as input data, a qualified talent profile associated with a qualified person. As discussed above, the talent profile is a data object including entries specifying different aspects of the qualified person. The qualified talent profile may include sections describing different aspects of the corresponding person. The information relating to the applicant may include feature values obtained from the HR database and may also include feature values obtained from external data sources such as professional web page, publications, and professional contributions to the public domains. The neural network module 900 may include an output layer including output 904 to produce embedding vectors each of which may correspond to a word or a collection of words (like sections) and represent the meaning in a compact dimension.

In one implementation, the deep neural network is realized using a general-purpose machine learning model called Bidirectional Encoder Representations from Transformers (BERT) model. In this disclosure, the BERT model includes different variations of BERT models including, but not limited to, ALBERT (a Lite BERT for Self-Supervised Learning of Language Representations), ROBERTA (Robustly Optimized BERT Pretraining Approach), and DistillBERT (a distilled version of BERT). The BERT models are particularly suitable for natural language processing (NLP).

To achieve deeper understanding of the underlying text, BERT models employ bidirectional training. Instead of identifying the next word in a sequence of words, the training of BERT models may use a technique called Masked Language Modeling (MLM) that may randomly mask words in a sentence and then try to predict the masked words from other words in the sentence surrounding the masked words from both left and right of the masked words. Thus, the training of the BERT models takes into consideration words from both directions simultaneously during the training process.

A linguistic unit such as a word or a phrase may be represented using an embedding vector which can be a vector of numerical values computationally derived based on a linguistic model. The linguistic model can be context-free or context-based. An example of the context-free model is word2vec that may be used to determine the vector representation for each word in a vocabulary. In contrast, context-based models may generate an embedding vector associated with word based on other words in a context (e.g., a paragraph). In BERT, the embedding vector associated with a word may be calculated based on other words within the input document using the previous context and the next context.

A transformer neural network (referred to as the “Transformer” herein) is designed to overcome the deficiencies of the recurrent neural network (RNN) and/or the convolutional neural network (CNN) architectures, thus achieving the determination of word dependencies among all words in a sentence with fast implementations using TPUs and GPUs. The Transformer may include encoders and decoders (e.g., six encoders and six decoders), where encoders have identical or very similar architecture, and decoders may also have identical or very similar architecture. The encoders may encode the input data into an intermediate encoded representation, and the decoder may convert the encoded representations to a final result. An encoder may include a self-attention layer and a feed forward layer. The self-attention layers may calculate attention scores associated with a word. The attention scores, in the context of this disclosure, measure the relevance values between the word and each of the other words in the sentence. Each relevance may be represented in the form of a weight value.

FIG. 10 illustrates a Bidirectional Encoder Representations from Transformers (BERT) model 1000 that may be trained to convert words or phrases into embedding vectors according to an implementation of the disclosure. Referring to FIG. 10, BERT model 1000 may include a preprocessing layer 1004 and multiple encoder layers 1006. Preprocessing layer 1004 may receive a stream of linguistic units (e.g., a section composed of words in a qualified talent profile), and convert each linguistic unit in the stream into a vector of combining the tokenization values, the index values, and the position values. For example, preprocessing layer 1004 may obtain a stream of words 1002 (e.g., Word 1, . . . , Word 5) as input to be converted into embedding vectors that each represents a corresponding word.

In one implementation, preprocessing layer 1004 may include one or more sub-layers of a token embedding layer, a segment embedding layer, and a position embedding layer. The token embedding layer may convert a word into a vector of token values, where the vector of token values has a predetermined dimension (e.g., a vector of 768 values). The token embedding layer may tokenize the word using a certain tokenization method such as the WordPiece method which is a data-driven method. The segment embedding layer may identify sentences and assign each sentence with an index value. Thus, each word in a sentence may be associated with an index value of the sentence. The index value associated with the word may take into consideration of the sentence structure in the qualified talent profile. The position embedding layer may assign each word with a position value within the sentence. In one implementation, the position embedding layer may include a look-up table of size (512, 768) where each row is a vector corresponding to a word at a position. Namely, the first row corresponds to a word at the first position in the sentence, and the second row corresponds to a word at the second position etc. The output of the token embedding layer, the segment embedding layer, and the position embedding layer may be combined (e.g., summed together) to form initial embedding vectors as input to the encoder layers 306. Each word input (e.g., Word 1, . . . , Word 5) may have a corresponding initial embedding vector.

Encoder layers 1006 may include multiple layers of encoders (e.g., 6 layers). The encoders may encode the input data into intermediate encoded representations. An encoder may include a self-attention layer and a feed forward layer. The self-attention layers may calculate attention scores associated with a word. The attention scores, in the context of this disclosure, measure the relevance values between the word and each of the other words in the sentence. Each relevance may be represented in the form of a weight value.

The self-attention layer may receive the intermediate representation of each word from a previous layer (or the preprocessing layer if the encoder layer is the first encoder layer). Each of the intermediate representation can be a type of word embedding which can be a vector including 512 data elements. The self-attention layer may further include a projection layer that may project the input word embedding vector into a query vector, a kay vector, and a value vector which each has a lower dimension (e.g., 64). The scores between a word and other words in the input sentence are calculated as the dot product between the query vector of the word and key vectors of all words in the input sentence. The scores may be fed to a Softmax layer to generate normalized Softmax scores that each determines how much each word in the input sentence expressed at the current word position. The attention layer may further include the multiplication operations that multiply the Softmax scores with each of the value vectors to generate the weighted scores that may maintain the value of words that are focused on while reducing the attentions to the irrelevant words. Finally, the self-attention layer may sum up the weighed scores to generate the attention values at each word position. The attention scores are provided to the feed forward layer which forwards the word embeddings of the present encoder layer to the next one. The calculations in the feed forward can be performed in parallel while the relevance between words is reflected in the attention scores. The eventual output of the stacked-up encoder layers 306 are the embedding vector (e.g., EV1, . . . , EV5) for each word. The embedding vectors that each include numerical values may capture the meaning of the word by taking into the context of the word in a sentence.

BERT models may be trained using bidirectional training. Instead of identifying the next word in a sequence of words, the training of BERT models may use a technique called Masked Language Modeling (MLM) that may randomly mask words in a sentence and then try to predict the masked words from other words in the sentence surrounding the masked words from both left and right of the masked words. Thus, the training of the BERT models takes into consideration words from both directions simultaneously during the training process.

The underlying neural network module of an LLM may be trained using an iterative training process designed to improve the LLM's ability to understand and generate human-like text. FIG. 11 illustrates an example of a training process of the LLM neural network.

At 1101, a dataset of text may be collected from various sources and preprocessed, which includes cleaning (removing irrelevant information), tokenization (breaking down text into manageable units like words or subwords), and other steps like normalization (standardizing text format) and lemmatization (reducing words to their base or dictionary form).

During the process of cleaning, irrelevant or redundant information may be removed from the input data. It may include stripping out HTML tags, correcting typos, removing stop words (common words like “the,” “is,” etc., that do not add much meaning to a sentence), and eliminating special characters. The goal is to ensure that the data is in a uniform and simplified format that is conducive to processing by the LLM neural network. Following cleaning, a tokenization process may break down the text into manageable units, such as words or subwords. The tokenization process may transform the cleaned text into a format that the LLM can understand and process. Tokens are the basic building blocks for the LLM to analyze and learn from the text, enabling it to generate or comprehend language based on these discrete pieces.

At 1102, model initialization may be applied, and initial values may be assigned to weights and biases of the LLM neural network before training begins. The weights serve as parameters that dictate the magnitude of influence each neuron's output exerts on the subsequent layer. Initializing these weights may include selecting a method to assign initial values. The weights may be set to small random numbers to ensure that neurons start off in a slightly different state, facilitating diverse learning paths. Techniques like Xavier/Glorot initialization or He initialization may be used, as they adjust the scale of the initial weights based on the number of input and output neurons in each layer, aiming to maintain a balance that prevents gradients from vanishing or exploding during the early phases of training.

In examples, biases may be added to the weighted sum of inputs to each neuron, allowing the activation function to shift left or right. The biases may be initialized to zero or small constants. Initializing biases to zero is common and practical because the randomness of weights is sufficient to break symmetry between neurons in the same layer, allowing them to learn different features.

The process of model initialization sets the stage for training by preparing the LLM neural network with a starting point from which it can begin to adjust its weights and biases based on the input data and the learning task at hand.

During the training phase, textual input data may be fed into the neural network. The network processes this input through its layers, each of which performs specific computations using activation functions. This step is known as forward propagation, where the network makes predictions based on its current state (weights). At 1103, the forward propagation begins as the input data, often in the form of vectorized tokens representing text, are inputted into the LLM. Each input vector may pass through the network's layers, starting from the input layer, moving through hidden layers, and finally reaching an output layer. At each layer, the input may undergo a transformation based on the layer's weights and biases, followed by the application of an activation function.

In each layer of the network, the input data may be multiplied by the layer's weights, and the biases may be added to the multiplied results. This operation produces a weighted sum for each neuron in the layer. Activation functions may be applied to these weighted sums. The activation functions, such as ReLU (Rectified Linear Unit) or sigmoid, may introduce non-linearity into the LLM, allowing it to learn and model complex patterns in the data.

As the processed data moves from one layer to the next, the LLM may incrementally extract and process features, with early layers identifying basic patterns and later layers interpreting more complex structures. Once the data has passed through all layers, the final output may be produced, representing the LLM's prediction or response to the input prompt. This output may be evaluated against an expected result, and the difference informs the LLM's adjustments during the backpropagation step, leading to learning and model improvement over time.

Subsequent to the forward propagation step, a comparison may be conducted between the LLM's generated predictions and the predetermined desired output. At 1104, a designated loss function calculates the variance between the LLM's predictions and the actual outcomes. This calculated variance, or “loss,” serves as a quantitative measure of the LLM's performance efficacy.

At 1105, a backpropagation operation may be applied. The procedure of backpropagation may include several steps aimed at optimizing the neural network's weights to minimize the loss function. The first step is gradient calculation. For each weight in the network, the partial derivative of the loss function with respect to that weight is computed. This calculation utilizes the chain rule of calculus to determine an impact of weights modification on the overall loss. The second step is propagation of gradients. Starting from the output layer and moving backward through the network, gradients may be propagated to all weights in the network. The backward movement may provide that the contribution of each weight to the final loss is accounted for, allowing for precise adjustments.

Subsequent to the calculation of gradients, at 1106, an update procedure may be applied to the weights within the network, aligning with a trajectory that facilitates a reduction in loss. This update process is executed through the utilization of optimization algorithms, such as Stochastic Gradient Descent (SGD) or alternative methodologies such as Adam or RMSprop. The magnitude of adjustment applied in the direction of the gradient may be regulated by a parameter, identified as a learning rate, determining an extent of each update step.

At 1107, an iteration and convergence operation may be applied and the operations 1103 to 1106 may be repeated for multiple iterations over the dataset. With each iteration, the LLM's weights may be adjusted to minimize the loss. Gradually, the LLM progresses toward a condition wherein its forecasts align closely with the intended outcomes.

After the initial training, the LLM may be evaluated on a separate dataset not previously encountered during training, known as a validation dataset, to measure its performance. At 1108, based on this evaluation, the LLM may undergo fine-tuning, where it is trained further with adjusted parameters or additional data to improve its accuracy.

At 1109, once trained and fine-tuned, the LLM may be equipped for deployment, enabling it to execute functions such as generating text, translating languages, summarizing content, among others, based on the training it received.

A Large Language Model (LLM) is configured to receive, interpret, and generate human-like text based on input prompts, leveraging a deep neural network architecture. This system may include multiple operational stages designed to understand and manipulate natural language text in a manner that mimics human cognitive abilities, thereby facilitating a wide range of applications from automated content creation to interactive dialogue systems. Once a LLM has been trained, the LLM may process input prompts and generate outputs that are coherent and contextually appropriate. FIG. 12 illustrates an example of the operation stages of an LLM.

At 1201, an initial step in the operation may include a reception of an input prompt by the LLM. At this stage, the LLM is configured to receive input in the form of natural language text from a user or an automated system. Upon receiving the input prompt, the LLM may employ an interface mechanism designed to facilitate a transmission of textual data into the LLM's processing framework. The interface mechanism ensures that the input prompt is captured and relayed to the subsequent stages of the LLM's operational pipeline without alteration or loss of information. The interface mechanism may handle various input formats, including but not limited to, plain text, voice-to-text conversions, and digital text submissions through various communication protocols. The LLM's capability to receive input prompts may enable users to interact with the LLM in a natural and intuitive manner. The input prompt may be a question, a statement, or a command. The flexibility and efficiency of the input reception process are pivotal in facilitating a wide array of applications, from automated content creation to sophisticated conversational interactions.

At 1202, the LLM may process the received prompt. The prompt may be segmented into individual tokens via tokenization for efficient model processing. These tokens may be transformed into vector representations through embedding, which encapsulates semantic and syntactic language attributes. Each vector represents the token in a high-dimensional space, capturing both the word's meaning and its usage in context. This approach allows the LLM to understand similarities and differences between words.

In examples, positional encoding may be applied, providing the LLM with an understanding of the order of tokens within the input sequence. This positional encoding may include assigning a unique identifier to each token position, ensuring the LLM can discern the sequence in which words appear. This encoding may be integrated with the token vectors before further processing, allowing the LLM to maintain the sequential context throughout its operations.

At 1203, upon processing the prompt, the LLM may apply its neural network hierarchy to interpret it. Through self-attention mechanisms, the LLM may assess relevance of each token within the context of the prompt and learn the task's requirements comprehensively. Self-attention mechanisms may allow the LLM to prioritize certain parts of the input text that are more relevant for generating a coherent response. This process enhances the coherence of the generated text, as the LLM is better able to understand and maintain the context and relationships between words and phrases within the text. The self-attention mechanism may operate after the positional encoding has been applied to the token vectors. The positional encoding provides model information about the order of words in a sentence, and self-attention uses this information to assess and prioritize parts of the text for generating output. This sequential process allows the LLM to understand both the context and significance of each word within the sentence, enhancing the overall coherence and relevance of the generated text.

At 1204, after the self-attention mechanism, the LLM may apply normalization and process the data through feed-forward networks between layers. Normalization may enhance stabilization of learning processes by providing that activation levels throughout the network remain within predefined thresholds, thereby preventing occurrence of excessively high or low activation states. Subsequent to the normalization procedure, feed-forward networks may be configured to process the normalized data through the application of non-linear transformations. The non-linear transformation may facilitate an extraction and assimilation of intricate patterns inherent within data. This sequence of operations, normalization followed by processing through feed-forward networks, occurs iteratively across the LLM's layers, enhancing its learning and pattern recognition capabilities.

At 1205, the LLM may generate output text by sequentially predicting a most probable next token given the context of the input prompt and the tokens generated. This process includes calculating a likelihood of all possible next tokens based on the LLM's trained parameters and selecting the token with a highest probability. The selected token is then appended to the sequence of generated tokens. This step may be repeated iteratively until the LLM produces a termination token or reaches a predefined maximum length, culminating in the generation of a coherent and contextually relevant text output. The output generation process leverages the LLM's learned linguistic patterns and knowledge, enabling it to compose text that aligns with the initial prompt's intent.

After an LLM is trained, the LLM may be deployed on a computer system for execution. Referring to FIG. 1, Responsive to the enriched prompt, processing device 102 may execute the LLM engine to generate a deep and customized job profile. Compared to drafting by a human user, the job description generated by the LLM engine may include information specified in the original request and information that was not specified in the original request but instead derived in the pre-processing operations. For example, the derived information may include skills that are unidentified but similar to the those specified in the request or skills that are identified in the talent profiles of other talents that had been hired for this job position or similar job positions. FIG. 4 illustrates an example job description 402 that is generated by an LLM engine. Compared to a human-drafted job description, the LLM-generated job description may be more informative and more helpful for a job candidate to learn about the job position. Implementations of the disclosure may also provide a GUI element 404 for the user to select a suitable language for the job description. For example, the user may use GUI element 404 to select a different language other than English. In one implementation, the selection of the language may trigger a straight translation of the English job description. In another implementation, the selection of a different language may trigger a rerun of the LLM engine to directly generate a job description in the language. In this way, the LLM engine may take into account factors that are related to the language and trained into the LLM engine. For example, if the selected language is Japanese, the rerun of the LLM engine may take into account the factors relating to Japan that is built into the LLM engine. Here, the prompt can still be in English but the output is in one or more different languages (e.g., Japanese, Germany etc.).

The LLM engine may be tuned to focus on different sections of requirements based on the understanding of the job position. For example, in one implementation, the prompt to the LLM engine may include a request to focus on the requirements of skills and capabilities for the candidates. In another implementation, the prompt to the LLM engine may include a request to focus on the requirements on seniority of work experience such as a reliance on tenure.

Referring to FIG. 1, after generating the job description, at 126, processing device 102 may execute deep job profile customization application 108 to perform post-processing operations on the generated job description to further generate a customized job description. The job description generated by the LLM engine may further processed for diversity and inclusiveness checks. The LLM engine may not prevent exclusive languages from being generated into the job description. Therefore, it may be helpful to have a post-processing layer for inclusiveness check. This layer may examine the text of the job description to search for exclusive words and suggest alternative inclusive words that may replace the exclusive words based on the context of the underlying text.

Exclusive language in this disclosure refers to the use of words or phrases that may tend to favor certain individuals or groups based on protected characteristics such as their race, skin color, gender, sexual orientation, age, disability, etc. Exclusive language affects both individuals and organizations. Such tendency can be pre-computed through examining a corpus of training data with the ground truth labels of gender, or other characteristics. The training data can be gathered from multiple companies, can be industry-specific, or can be tied to a particular job function. The exclusivity impact to individuals includes discouraging qualified candidates from applying, creating barriers for individuals, who do not identify themselves with the characteristics of the terms used. The impact to organizations includes a lack of diversity in the application pool and the hindrance of innovation and growth.

Inclusivity/exclusivity check and recommendation can be built at the both front end in the pre-processing operations and at the backend in the post-processing operations of the large language model. For example, inclusivity substitution of exclusive words in the prompt generation may help preempt potential bias of a previously trained large language model on corpuses. The output of the large language model can also be subject to the checks of inclusivity and exclusivity, including prompting on user interfaces for manual substitution and recommendation, or through automatic thresholding for automatic substitution of the most unbiased alternatives. For the exclusive word detection, processing device 102 may execute deep job profile customization application 108 to scan the text of the job description for any potential exclusive words that are stored in an exclusive word dictionary. Responsive to detecting any exclusive words, processing device 102 may determine inclusive words that semantically similar to the exclusive words and present these inclusive words as alternatives to the exclusive words on a user interface. FIG. 5 illustrates a user interface 500 for a user to select alternative inclusive words for exclusive words. As shown in FIG. 5, processing device 102 may detect and highlight potential exclusive words “man hours” on the user interface 500. Processing device 102 may present an explanation of why “man hours” is considered exclusive words and recommend alternative inclusive words such as “staff hours,” “hours,” “hours of work,” “hours of labor,” or keep the same for a user to select. Responsive to user selection of an alternative word (e.g., “hours”), processing device 102 may substitute the exclusive words “man hours” with the inclusive word (e.g., “hour”).

After the job description is processed to remove or substitute any potential exclusive words, at 128, processing device 102 may further provide the customized job profile to a user interface for presentation to the user. Processing device 102 may use a separate or equivalent LLM to format of the customized job description to a form that is suitable for question-and-answer tasks. The job description may be converted into a structured format or template. One such example could be a JSON representation of job description that clearly denotes sections like “Company Description”, “Requisite Requirements”, “Nice-to-Have Requirements” etc. The LLM can now understand the underlying structure and generate similar templates.

Similar to the job profile customization, the large language model (LLM) may also be used in customizing a talent profile. As discussed with details in conjunction with FIG. 1, a talent profile 116 may include information characterizing all aspects of a talent who can be an applicant, a candidate or an employee. Talent profiles stored in an information system 114 may be made available to users (e.g., the hiring managers or the talents themselves) to review and edit. The employee talents may use the talent customization system to build their career profiles by providing supporting documents such as resumes, cover letters, etc. in addition to curating or updating experience, education, skills and capabilities information. They can optionally add other information such as projects, courses, patents, publications etc. to their talent profiles. The external candidates may log into the talent customization system and have the same control over their profiles as employee talents without the organization specific information like internal projects. When logged out, the external candidate may provide only a resume. A hiring manager may use the talent customization system to review talent profiles and add evaluation and hiring decisions (e.g., interviews, feedbacks, and offers).

For all the above scenarios, there is a need to present the information in a clear, consistent, and concise manner. For example, to review the high volume of candidates for a given opportunity available at a company, a recruiter responsible for hiring the role may have only a limited time to review the high volume of talent profiles. There is a need to customize the talent profiles to a format that can be reviewed and decided quickly. Implementations of the disclosure may use a large language model (e.g., a Generative Large Language Model) to distill and summary a talent profile into a concise briefing, while preserving the ability to examine the gist of the entire profile.

Implementations of the disclosure may take advantage of LLMs because LLMs are particularly suitable for generating relevant, coherent, and grammatically-correct textual description when given a properly designed prompt to the LLM. The LLM may generate natural language text that may be used in a wide range of applications. For a geographically-diverse organization (e.g., a company across multiple countries), multilingual job descriptions will help serve the organization with better talent pools, and an LLM trained on large corpuses of international languages is particularly suited for inter-language context correlation and generation of multiple job description pairs (or, summaries of talent profiles in two or more languages).

FIG. 6 illustrates the computer system 100 implementing a software application for deep talent profile customization 600 according to an implementation of the disclosure. The architect and components of computer system 100 have been described in detail in conjunction with FIG. 1 and for conciseness of the description, is not repeated. Referring to FIG. 6, a deep talent profile customization application 600 may include operations 602.

At 604, processing device 102 may obtain a request for customizing a talent profile 116 for a job profile (e.g., a target job position), and identify, from a talent database (e.g., information system 114), the talent profile based on requirements in the job profile. The request can be one for generating summaries of talent profiles with respect to a job opening characterized by the job profile. The requirements in the job profile can be the job title and/or skills required by the job profile.

At 606, processing device 102 may perform pre-processing operations on the request to generate a prompt to a large language model (LLM). Rather than feeding the request as a prompt directly to the LLM, implementation may first perform pre-processing to enrich the prompt so that the LLM may be provided with more specific hints about how to generate the summaries. In one implementation, the pre-processing may include identification of a context for the summarization of talent profiles. The context can be a use scenario. For example, the context can be one for a recruiter to perform quick reviews of talent profiles for a specific job profile. Another context can be for a candidate to review his or her profile in a highlighted way with respect to a job profile. When provided with an identified context, pre-processing operations 606 may add the context information to the prompt provided to the LLM.

At 608, processing device 102 may execute the LLM based on the context-aware prompt to generate a context-dependent summary of a talent profile. In the recruiter context, the context-dependent summary may highlight aspects of the talent profile that are most relevant to the job requirements of the specific job profile.

To achieve such highlighting, processing device 102 may take into account the job requirements in the job profile for a specified position. The job requirements can be hard requirements such as requisite skills. Processing device 102 may examine the candidate talent profile at issue and compare the skill requirements and adjacent skills against the candidate talent profile's skill extractions, using machine learning techniques, including those matching technologies described in U.S. Pat. No. 10,803,421, the content of which is incorporated by reference herein. Taking into account which skills the candidate may possess but have not expressly described, the system may be flexible enough to write a summary that takes into positive examples of skills that are either present or likely to present, and negative examples of skills that are deemed missing. The positive and negative examples can form parts of the prompt that are fed into the large language generative model. The context-dependent summarization can be integrated deeply into various aspects of the talent intelligence ecosystem, ranging from providing feedback to the recruiter, to evaluating the candidate and enabling outreach for the candidates.

Deep talent profile customization application 600 may also generate context-free summary of a talent profile. To generate the context-free summary, processing device 102, at 610, may provide a prompt without a specification of a context to the LLM engine for generating a context-free summary. The prompt could be a simple instruction to summarize the talent profile. After 610, a talent profile can be associated with a context-dependent summary and a context-free summary. If a talent profile is associated with both types of summaries, these summaries can be integrated into an Extract, Transform, and Load (ETL) framework to enable intuitive and efficient natural language search. This is especially powerful for searching through candidates and employees.

At 612, processing device 102 may provide customized talent profile including both the context-dependent and context-free summaries to a search engine that is coupled with a user interface. The user interface may include a graphic user interface (GUI) that can answer questions like “Who in my organization can do Implementation?” with particularized and relevant returns.

An implementation of such question and answer capabilities is illustrated below. The implementation can retrieve past positions that perform the task of implementation, for example based on the keyword searches in past job descriptions and job calibrations performed by the recruiters of the organization. The keyword search may be expanded to include similar and adjacent keywords to significantly increase the recall of the relevant positions. Against those positions, a large language model (e.g., GPT-3.0 or GPT-4.0) is applied to each of the talent profiles of potential candidates in the database to generate context-dependent summaries of talent profiles. These summaries can be expressed in text, or can be encoded in the embedding vector representation of the large language model. A different large language model may be used to generate the embedding.

Separately, context-free summaries can be generated for the potential candidates based on the career profile input by the candidate. Based on both the context-dependent and context-free summaries of a talent profile, the system can combine and perform fast ranking and retrieval of candidates that best match to the positions that the talent has been identified to perform the task of implementation. In one implementation, the combination may include a weighted sum of a distance metric between each of the context-dependent summary/context-free summary and the position identified. Assume that the distance metric between the context-dependent summary and the job profile for the position is D_{cd} and the distance metric between the context-free summary and the job profile for the position is D_{cf}, the weighted sum of the two distance metrics can be S=a*D_{cd}+(1−a)*D_{cf}, where a is the weight, and the distance metric can be a Euclidean distance, a Cosine distance, Manhattan distance or equivalent distance between two vector representations. Once the distance measures are calculated for each pair of position and potential candidate, sorting and filtering capabilities can be provided to a user interface to search either jobs or candidates or both, depending on the specific application in the talent processes.

FIG. 7 illustrates a user interface 700 for question and answer based on a deep talent profile customization provided to a search engine. As shown in FIG. 7, user interface 700 may include a first portion 702 for a user to enter a question (e.g., “I want to learn more about implementation and who can help me with implementation for a group ID for a new customer account.”). Responsive to obtaining the question or request, a deep talent profile customization application as described in FIG. 6 may identify skills required based on prior similar implementation projects and identify suitable talents in the database based on deep talent profile customization. Further, user interface 700 may include a second portion 704 for presenting the results in the forms of links to suitable talent profiles. In this way, the user may select the talent that may help with the implementation project. This user interface example is based on a natural language text queries. For a smooth mobile experience, a voice user interface may be implemented to receive voice commands for questions and answers.

The generated summaries may undergo through an inclusivity check in a post-processing, where exclusive words are substituted to eliminate bias and reduce discriminatory effects. As discussed above, exclusive language refers to the use of words or phrases that may tend to favor certain individuals or groups based on protected characteristics such as their race, color, gender, sexual orientation, age, ability, etc. Exclusive language affects both individuals and organizations. Such tendency can be pre-computed through examining a corpus of training data with the ground truth labels of gender, or other characteristics. The training data can be gathered from multiple companies or can be industry-specific. The exclusivity impact to individuals include discouraging qualified candidates from applying, creating barriers for individuals, who do not identify themselves with the characteristics of the terms used. The impact to organizations includes a lack of diversity in the application pool and the hindrance of innovation and growth. Inclusivity/exclusivity check and recommendation can be built at the both front end and back end of the large language model processing. For example, inclusivity substitution of the prompt generation will help preempt potential bias of a previously trained large language model on corpuses. The output of the large language model can also be subject to the checks of inclusivity and exclusivity, including prompting on user interfaces for manual substitution and recommendation, or through automatic thresholding for automatic substitution of the most unbiased alternatives.

The overall architecture of the system may include following operations:
1. An ecosystem that builds a structured profile (manual or automatic) as a collection of experiences, education, skills and capabilities, courses, patents, publications etc.;
2. For a pool of target positions, profiles may be enhanced with positional requirements to form customized prompt;
3. The prompts with contexts may serve as input to a Generative LLM to generate customized summaries;
4. Post processing:
   a. Exclusive language checks on the customized summaries;
   b. Context-dependent summaries and context-free summaries can be combined and provided to a search engine for ranking and retrieval;
5. Integrate the summaries with a user interface of an ETL framework to provide search capabilities (e.g., a question-and-answer user interface that may answer a question such as “who in my organization can do implementation?”).

FIG. 8 illustrates a flowchart of a method 800 for deep job profile customization according to an implementation of the disclosure. Method 800 may be performed by processing devices that may comprise hardware (e.g., circuitry, dedicated logic), computer readable instructions (e.g., run on a general purpose computer system or a dedicated machine), or a combination of both. Method 800 and each of its individual functions, routines, subroutines, or operations may be performed by one or more processors of the computer device executing the method. In certain implementations, method 800 may be performed by a single processing thread. Alternatively, method 800 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

As shown in FIG. 8, one or more processing devices may, at 802, obtain a request for generating a job profile targeted to attract job candidates.

At 804, the one or more processing devices may perform pre-processing operations on the request to generate a prompt to a large language model engine.

At 806, one or more processing devices may input the prompt to the large language model engine and receive a job description generated by the large language model engine.

At 808, one or more processing devices may perform post-processing operations on the generated job description to generate a customized job description.

At 810, one or more processing devices may one or more processing devices may provide the customized job description to a user interface for presentation.

FIG. 13 depicts a block diagram of a computer system 1300 operating in accordance with one or more aspects of the present disclosure. In various illustrative examples, computer system 1300 may implement operations 118 for job profile customization as shown in FIG. 1 or operations 602 for talent profile customization as shown in FIG. 6.

In certain implementations, computer system 1300 may be connected (e.g., via a network, such as a Local Area Network (LAN), an intranet, an extranet, or the Internet) to other computer systems. Computer system 1300 may operate in the capacity of a server or a client computer in a client-server environment, or as a peer computer in a peer-to-peer or distributed network environment. Computer system 1300 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1300 may include a processing device 1302, a volatile memory 604 (e.g., random access memory (RAM)), a non-volatile memory 1306 (e.g., read-only memory (ROM) or electrically-erasable programmable ROM (EEPROM)), and a data storage device 1316, which may communicate with each other via a bus 1308.

Processing device 1302 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1300 may further include a network interface device 1322. Computer system 1300 also may include a video display unit 1310 (e.g., an LCD), an alphanumeric input device 1312 (e.g., a keyboard), a cursor control device 1314 (e.g., a mouse), and a signal generation device 1320.

Data storage device 1316 may include a non-transitory computer-readable storage medium 1324 on which may store instructions 1326 encoding any one or more of the methods or functions described herein, including instructions for performing operations 118 of FIG. 1 for implementing method 800.

Instructions 1326 may also reside, completely or partially, within volatile memory 1304 and/or within processing device 1302 during execution thereof by computer system 1300, hence, volatile memory 1304 and processing device 1302 may also constitute machine-readable storage media.

While computer-readable storage medium 1324 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A system comprising one or more processing devices and one or more storage devices for storing instructions that when executed by the one or more processing devices cause the one or more processing devices to:
obtain a request for generating a job description directed towards job candidates;
perform pre-processing operations on the request to generate a prompt to a large language model engine;
submit the prompt to the large language model engine and receive a job description generated by the large language model engine;
perform post-processing operations on the generated job description to generate a customized job description; and
provide the customized job description to a user interface for presentation.

2. The system of claim 1, wherein to perform the pre-processing operations, the one or more processing devices are further to:
determine one or more aspects required by the request, wherein the one or more aspects comprise at least one of a role or a skill associated with a job;
determine a plurality of qualified profiles that meet the one or more aspects required by the requests; and
determine a plurality of skills based on the one or more aspects and the plurality of qualified profiles; and
generate the prompt based on the plurality of skills.

3. The system of claim 1, wherein to perform the pre-processing operations, the one or more processing devices are further to:
determine one or more exclusive words in the prompt using diversity rules; and
substitute the one or more exclusive words using inclusive words in the prompt.

4. The system of claim 1, wherein the request comprises a target language, and wherein the job description is generated by the large language model engine in the target language or a language other than the target language.

5. The system of claim 1, wherein to perform the post-processing operations, the one or more processing devices are further to:
determine whether the customized job description includes exclusive words; and
responsive to determining the exclusive words in the customized job description, substitute the exclusive words using inclusive words.

6. The system of claim 1, wherein the customized job description is formulated in a structured format, and wherein the customized job description comprises skills and their associated relevancy to a target job.

7. The system of claim 1, wherein the one or more processing devices are further to:
identify, from a talent database, a candidate talent profile for the customized job description;
generate a second prompt based on the candidate talent profile and the customized job description, and a context of the customized job description;
submit the second prompt to the large language model engine and receive a context-dependent summary of the candidate talent profile;
perform the post-processing operations on the context-dependent summary to generate a processed context-aware summary; and
provide the processed context-aware summary to the user interface for presentation.

8. The system of claim 7, wherein the one or more processing devices are further to:
generate a third prompt that requests a context-free summary of the candidate talent profile;
submit the third prompt to the large language model engine and receive a context-free summary of the candidate talent profile; and
provide the context-free summary to the user interface for presentation.

9. The system of claim 8, wherein the one or more processing devices are further to:
responsive to receiving a question for identifying a second talent to perform a task, obtain a context-dependent summary and a context-free summary of a second talent profile associated with the second talent;
calculate a weighted combination of the context-dependent summary and the context-free summary of the second talent profile;
determine, based on the weighted combination, that the second talent is capable of performing the task; and
provide a representation of the second talent profile on the user interface.

10. The system of claim 7, wherein the one or more processing devices are further to:
execute a machine learning module using the candidate talent profile and the customized job description as inputs to calculate a matching score between the candidate talent profile and the customized job description; and
provide the matching score to the user interface for presentation.

11. A system comprising one or more processing devices and one or more storage devices for storing instructions that when executed by the one or more processing devices cause the one or more processing devices to:
obtain a request for customizing a talent profile targeted to a job profile, and identify, from a talent database, the talent profile based on requirements in the job profile;
perform pre-processing operations on the request to generate a context-aware prompt to a large language model engine;
submit the context-aware prompt to the large language model engine and receive a context-dependent summary of the talent profile;
submit a context-free prompt to the large language model engine and receive a context-free summary of the talent profile generated by the large language model engine; and
provide the context-dependent summary and context-free summary to a search engine for retrieval.

12. The system of claim 11, wherein the one or more processing devices are further to:
responsive to receiving a question for identifying a second talent to perform a task, obtain a context-dependent summary and a context-free summary of a second talent profile associated with the second talent;
calculate a weighted combination of the context-dependent summary and the context-free summary of the second talent profile;
determine, based on the weighted combination, that the second talent is capable of performing the task; and
providing a representation of the second talent profile on the user interface.

13. A method, comprising:
obtaining a request for generating a job description directed towards job candidates;
performing pre-processing operations on the request to generate a prompt to a large language model engine;
submitting the prompt to the large language model engine and receive a job description generated by the large language model engine;
performing post-processing operations on the generated job description to generate a customized job description; and
providing the customized job description to a user interface for presentation.

14. The method of claim 13, wherein performing the pre-processing operations further comprises:
determining one or more aspects required by the request, wherein the one or more aspects comprise at least one of a role or a skill associated with a job;
determining a plurality of qualified profiles that meet the one or more aspects required by the requests; and
determining a plurality of skills based on the one or more aspects and the plurality of qualified profiles; and
generating the prompt based on the plurality of skills.

15. The method of claim 13, wherein the request comprises a target language, and wherein the job description is generated by the large language model engine in the target language or a language other than the target language.

16. The method of claim 13, wherein performing the post-processing operations further comprises:
determining whether the customized job description includes exclusive words; and
responsive to determining the exclusive words in the customized job description, substituting the exclusive words using inclusive words.

17. The method of claim 13, further comprising:
identifying, from a talent database, a candidate talent profile for the customized job description;
generating a second prompt based on the candidate talent profile and the customized job description, and a context of the customized job description;
submitting the second prompt to the large language model engine and receive a context-dependent summary of the candidate talent profile;
performing the post-processing operations on the context-dependent summary to generate a processed context-aware summary;
providing the processed context-aware summary to the user interface for presentation;
generating a third prompt that requests a context-free summary of the candidate talent profile;
submitting the third prompt to the large language model engine and receive a context-free summary of the candidate talent profile; and
providing the context-free summary to the user interface for presentation.

18. The method of claim 17, further comprising:
responsive to receiving a question for identifying a second talent to perform a task, obtaining a context-dependent summary and a context-free summary of a second talent profile associated with the second talent;
calculating a weighted combination of the context-dependent summary and the context-free summary of the second talent profile;
determining, based on the weighted combination, that the second talent is capable of performing the task; and
providing a representation of the second talent profile on the user interface.

19. A method, comprising:
obtaining a request for customizing a talent profile targeted to a job profile, and identify, from a talent database, the talent profile based on requirements in the job profile;
performing pre-processing operations on the request to generate a context-aware prompt to a large language model engine;
submitting the context-aware prompt to the large language model engine and receive a context-dependent summary of the talent profile;
submitting a context-free prompt to the large language model engine and receive a context-free summary of the talent profile generated by the large language model engine; and
providing the context-dependent summary and context-free summary to a search engine for retrieval.

20. The method of claim 19, further comprising:
responsive to receiving a question for identifying a second talent to perform a task, obtaining a context-dependent summary and a context-free summary of a second talent profile associated with the second talent;
calculating a weighted combination of the context-dependent summary and the context-free summary of the second talent profile;
determining, based on the weighted combination, that the second talent is capable of performing the task; and
providing a representation of the second talent profile on the user interface.
